(19) United States
(12) Patent Application Publication
(10) Pub. No.: US 2007/0169885 A1
(43) Pub. Date: Jul. 26, 2007

(54) Thermally conductive pressure-sensitive adhesive composition, thermally conductive sheet-form molded foam, and process for producing the same

(76) Inventors: Takamitu Mikuni, Tokyo (JP); Satosi Iwabuchi, Tokyo (JP); Manabu Ogiwara, Tokyo (JP)

Correspondence Address: BIRCH STEWART KOLASCH & BIRCH, PO BOX 747, FALLS CHURCH, VA, 22040-0747, US

(21) Appl. No.: 10/582,985

(22) PCT Filed: Dec. 14, 2004
(86) PCT No.: PCT/JP04/18634

§ 371 Date: Jun. 15, 2006

(30) Foreign Application Priority Data
Dec. 18, 2003 (JP) 2003-421281
Feb. 24, 2004 (JP) 2004-047208
Mar. 23, 2004 (JP) 2004-084323

(51) Int. Cl. C04B 37/00

(52) U.S. Cl. 156/325

(57) ABSTRACT

The present invention provides a thermally conductive pressure-sensitive adhesive composition comprising an acrylic (or methacrylic) ester copolymer obtained by polymerizing a monomer mixture comprising an acrylic (or methacrylic) estermonomer capable of forming a homopolymer having a glass transition temperature of −20° C. or lower, a monomer having an organic acid group, and a monomer copolymerizable with these monomers in the presence of a copolymer comprising acrylic (or methacrylic) ester monomer units capable of forming a homopolymer having a glass transition temperature of −20° C. or lower, monomer units having an organic acid group, monomer units having a functional group other than any organic acid group and monomer units copolymerizable with these monomer units, and a metal hydroxide, wherein the acrylic (or methacrylic) ester copolymer is foamed, the composition being excellent in balance between hardness and pressure-sensitive adhesive property, having excellent shape-conformability and other performances, and being able to be made into a sheet easily be molded and the obtained sheet can easily be peeled from an adherend to which the sheet adheres easily after the sheet is used; a thermally conductive sheet-form molded foam comprising this composition; and a process for producing the same.

### TECHNICAL FIELD

The present invention relates to a thermally conductive pressure-sensitive adhesive composition, a thermally conductive sheet-formmolded foam comprising the same, and a process for producing the thermally conductive sheet-form molded foam.

### BACKGROUND ART

With the recent advancement in the performance of electronic parts, such as a plasma display panel (hereinafter, abbreviated as “PDP” in some cases) and integrated circuit (IC) chips, the amount of heat generated therefrom has increased. This results in a necessity that measures are taken against functional disorder caused by the temperature rising. In general, there are adopted methods for diffusing heat by fitting a heat radiating body such as a heat sink, a heat radiating metal plate or heat radiating fin to a heat generating body such as an electronic parts,. In order to attain the thermal conduction from the heat generating body to the heat radiating body effectively, various thermally conductive sheets are used. In general, however, a pressure-sensitive adhesive sheet is necessary for fixing the heat generating body and the heat radiating body to each other.

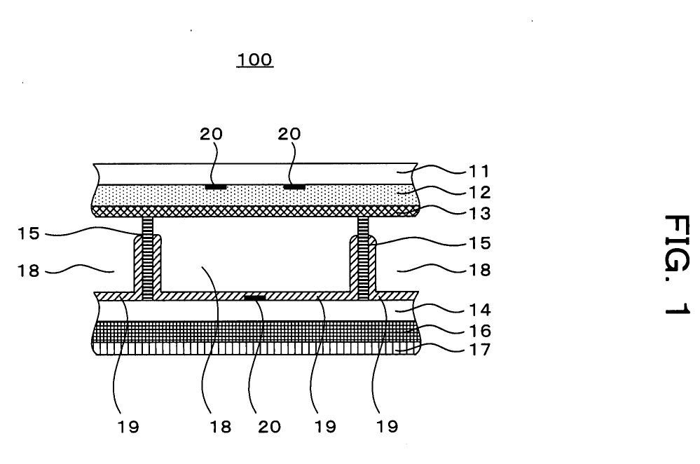

In FIG. 1 is illustrated a specific embodiment of a thermally conductive sheet-form molded foam having a thermally conductive pressure-sensitive adhesive composition of the present invention. An electronic parts 100 in FIG. 1 is a PDP. The PDP has a front glass 11, an insulator layer 12, a protecting film 13, and a rear glass 14. The front glass 11 and the rear glass 14 are superposed on each other at an interval of, for example, approximately 0.1 mm, and this interval is partitioned with dividing walls 15. Respective spaces partitioned with the dividing walls 15 (hereinafter, referred to as “cells 18,18,18, . . . ”) are each filled with a rare gas such as neon or xenon. When voltage is applied between two or more out of electrodes 20, 20, 20, . . . , electric discharge is caused. Ultraviolet rays generated by the discharge are radiated to fluorescent bodies 19 inside the cells 18, 18, 18, . . . , so as to emit light. On the other hand, heat generated due to the discharge or the like causes a drop in the performance of the PDP. It is therefore necessary to transfer the heat effectively to a heat radiating body 17. A heat radiating sheet 16, a typical example of which is a thermally conductive sheet-form molded body of the invention, has a function for transferring the heat. Accordingly, the thermally conductive sheet-form molded body of the invention is required to have a high thermal conductivity, and is further required to have an excellent sheet flatness or smoothness in order to prevent a decrease in the thermal conductivity of the sheet-form molded body due to the incorporation of air bubbles or the like between it and the rear glass 14 or the like, which is stuck thereon.

Patent Document 1 discloses a thermally conductive, electrically insulating, pressure-sensitive adhesive comprising: a polymermade from monomers including a polar monomer copolymerizable with an alkyl acrylate (or methacrylate); and thermally conductive, electrically insulating particles (a thermally conductive filler). Specifically, a pressure-sensitive adhesive is obtained by adding acrylic acid, alumina, and a crosslinking agent such as tripropylene glycol diacrylate to polyisooctyl acrylate syrup, and then subjecting the mixture to photopolymerization.

Patent Document 2 discloses a thermally conductive, pressure-sensitive adhesive comprising a photopolymer of a mixture composed of: a monomer mixture which is made mainly of an alkyl acrylate (or methacrylate) and contains no polar-group-containing monomer; a photopolymerization initiator; a polyfunctional acrylate (or methacrylate) as a cross binding agent; and a thermally conductive filler.

Patent Document 3 discloses a thermally conductive, pressure-sensitive adhesive wherein thermally conductive particles are incorporated into a copolymer made from an alkyl acrylate (or methacrylate) and a vinyl monomer satisfying a specific formula. The specific vinyl monomer used therein is preferably an especial monomer, such as an acrylate (or methacrylate) having a phosphoric acid group, or 2-hydroxy-3-phenoxypropyl acrylate.

The present Applicant suggested a pressure-sensitive adhesive composition comprising an acrylate (or methacrylate)-based polymer having a specific solvent-solubility (Patent Document 4).

Patent Document 5 suggests a pressure-sensitive adhesive composition which is foamed at a specific multiplying factor.

Pressure-sensitive adhesive, heat radiating sheets are sheets having adhesive property or tackiness for fixing a heat generating body and a heat radiating body to each other. However, the sheets are desired to be easily peeled from the heat generating body or the heat radiating body, when the sheets are recycled or abandoned after the use thereof.

As a technique related thereto, Patent Document 6 discloses a method of: incorporating, into a sheet, microcapsules wherein a thermally expandable material such as isobutane or pentane is encapsulated; heating the sheet after the use thereof at a temperature higher than that when the sheet is ordinarily used, thereby expanding the thermally expandable material; and forming irregularities in the sheet surface which contacts an adherend, thereby improving the peelability of the sheet.

Patent Document 7 discloses a method for improving the peelability by causing radial rays or ultraviolet rays to act, at high temperature, on a sheet comprising a foaming component having a t-butyloxycarbonyl structure and a foaming initiator capable of generating an acid by the radial rays or ultraviolet rays after the sheet is used, thereby generating gas and foaming the sheet.
Patent Document 1: Japanese Patent Application Laid-Open (JP-A) No. 6-088061
Patent Document 2: JP-A No. 10-324853
Patent Document 3: JP-A No. 2002-322449
Patent Document 4: JP-A No. 2002-285121
Patent Document 5: JP-A No. 2002-128931
Patent Document 6: JP-A No. 2002-134666
Patent Document 7: JP-A No. 2004-043732

### DISCLOSURE OF THE INVENTION

### Problems to be Solved by the Invention

However, about the pressure-sensitive adhesives disclosed in Patent Document 1 and 2, their hardness and their pressure-sensitive adhesive property are not easily balanced. In reality, photopolymerization is necessary for obtaining the pressure-sensitive adhesives; thus, facilities therefor are necessary. It is therefore difficult to say that these are economically advantageous.

In the method described in Patent Document 3, a specific monomer must be used in a large amount in order to obtain a considerable advantageous effect. Thus, it is difficult to say that the method is economically advantageous. There is also a problem that hardness and pressure-sensitive adhesive property are not easily balanced.

The composition described in Patent Document 4 overcomes the above-mentioned problems, but hardness and pressure-sensitive adhesive property are not sufficiently well balanced at ease. Furthermore, the shape-conformability thereof to a heat generating body having irregularities, or the like is not sufficient.

About the composition described in Patent Document 5, the shape-conformability to a heat generating body having irregularities, or the like is improved. However, the sheet has a problem about flame resistance, although the sheet is used in the state in contact with a heat generating body.

The method described in Patent Document 6 is a risky method of gasifying a substance having a high flammability and combustibility, and also has a problem that expensive microcapsules are used.

In the method described in Patent Document 7 also, a flammable gas, which may have flammability and combustibility, is generated at high temperature. Thus, the method has a problem about safety.

Thus, an adherend of the present invention is to provide a thermally conductive pressure-sensitive adhesive composition which has a sufficient pressure-sensitive adhesive property, is excellent in balance between hardness and pressure-sensitive adhesive property, shape-conformability, flame resistance, thermal conductivity and smoothness, and can be made into a sheet that can easily be molded and the obtained sheet can be peeled safely and easily from an adherend onto which the sheet adheres after the sheet is used; a thermally conductive sheet-form molded foam comprising this composition; and a process for the production thereof.

Means for Solving the Problems

To solve the above-mentioned problems, the inventors had repeated eager researches on a thermally conductive pressure-sensitive adhesive composition, a thermally conductive sheet-form molded foam comprising this composition, and a process for the production thereof, so as to make the following invention.

A first aspect of the invention is a thermally conductive pressure-sensitive adhesive composition, comprising 100 parts by weight of an acrylic (or methacrylic) ester copolymer (A) obtained by polymerizing 5to70parts by weight of a monomer mixture (A2m) comprising 40 to 100% by weight of an acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight, in the presence of 100 parts by weight of a copolymer (A1) comprising 80 to 99.9% by weight of acrylic (or methacrylic) ester monomer units (a1) capable of forming a homopolymer having a glass transition temperature of −20° C.or lower, 0.1 to20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total monomermixture (A1) is regarded as 100% by weight, and 70 to 170 parts by weight of a metal hydroxide (B), wherein the acrylic (or methacrylic) ester copolymer (A) is foamed.

In the thermally conductive pressure-sensitive adhesive composition, the multiplying factor of the foaming (the expansion ratio) is preferably from 1.05 to 1.4 times.

The thermally conductive pressure-sensitive adhesive composition may further comprise 0.1 to 5 parts by weight of silica (C) comprising primary particles having an average particle diameter of 5 to 20 nm and having a hydrophobicity ratio of 50% or less when it is based on a transmissivity method.

The thermally conductive pressure-sensitive adhesive composition may further comprise 0.05 to 10 parts by weight of a compound (D) having a melting point of 120 to 200° C. and a molecular weight of less than 1000.

The compound (D) is preferably an aliphatic amide compound.

The metal hydroxide (B) is preferably aluminum hydroxide.

A second aspect of the invention is a thermally conductive sheet-form molded foam which comprises the above-mentioned thermally conductive pressure-sensitive adhesive composition.

A third aspect of the invention is a thermally conductive sheet-form molded foam which comprises: a substrate; and one or more layers made of the above-mentioned thermally conductive pressure-sensitive adhesive composition and formed on a single surface or both surfaces of this substrate.

A fourth aspect of the invention is a process for producing a thermally conductive sheet-formmolded foam, which comprises:
the step of mixing 100 parts by weight of a copolymer (A1) comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total copolymer (A1) is regarded as 100% by weight, 5 to 70 parts by weight of a monomer mixture (A2m) comprising 40 to 100% by weight of an acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight,
a thermal polymerization initiator (E2) in an amount of 0.1 to 50 parts by weight for 100 parts by weight of the monomer mixture (A2m),
a metal hydroxide (B) in an amount of 70 to 170 parts by weight for 100 parts by weight of the total of the copolymer (A1) and the monomer mixture (A2m), thereby forming a mixture (F);
the step of foaming the mixture (F); the step of heating the mixture (F); and the step of making the mixture (F) into a sheet.

The step of the foaming the mixture (F) is preferably a step of foaming the mixture (F) to set the foaming multiplying factor thereof into the range of 1.05 to 1.4 times.

In the above-mentioned process for producing a thermally conductive sheet-form molded foam, the mixture (F) may be a mixture (G) wherein 0.05 to 10 parts by weight of a compound (D) having a melting point of 120 to 200° C. and a molecular weight of less than 1000 are further mixed with 100 parts by weight of the total of the copolymer (A1) and the monomer mixture (A2m).

In the above-mentioned process for producing a thermally conductive sheet-formmolded foam, the mixture (F) may be a mixture (G′) wherein 0.05 to 10 parts by weight of an aliphatic amide compound having a melting point of 120 to 200° C. and a molecular weight of less than 1000 are further mixed with 100 parts by weight of the total of the copolymer (A1) and the monomer mixture (A2m).

In the above-mentioned process for producing a thermally conductive sheet-form molded foam, the mixture (F), (G) or the mixture (G′) may be a mixture wherein 0.1 to 5 parts by weight of silica (C) comprising primary particles having an average particle diameter of 5 to 20 nm and having a hydrophobicity ratio of 50% or less when it is based on a transmissivity method, are further mixed with 100 parts by weight of the total of the copolymer (A1) and the monomer mixture (A2m).

In the above-mentioned process for producing a thermally conductive sheet-form molded foam, the metal hydroxide (B) is preferably aluminum hydroxide.

Effects of the Invention

The thermally conductive pressure-sensitive adhesive composition of the invention has a sufficient pressure-sensitive adhesive property, is excellent in balance between hardness and pressure-sensitive adhesive property, shape-conformability, flame resistance, thermal conductivity and smoothness, and can be made into a sheet that can easily be molded and the obtained sheet can be peeled safely and easily from an adherend onto which the sheet adheres after the sheet is used. Accordingly, the thermally conductive sheet-form molded foam obtained from this is useful as a thermally conductive sheet or the like for promoting thermal conduction effectively from a heat generating body of an electronic parts, such as a plasma display panel (PDP) or others to a heat radiating body thereof.

### BRIEF DESCRIPTION OF THE DRAWING

[FIG. 1] This is a schematic view illustrating a specific embodiment of the thermally conductive sheet-form molded foam.

### EXPLANATION OF REFERENCE NUMBERS

11 Front glass
12 Insulator layer
13 Protecting film
14 Rear glass
15 Dividing walls
16 Heat radiating sheet
17 Heat radiating body
18 Cells
19 Fluorescent bodies
20 Electrodes
100 Electronic parts

### BEST MODE FOR CARRYING OUT THE INVENTION

In the following, the invention will be ribed in detail.

The thermally conductive pressure-sensitive adhesive composition of the invention comprises, as a first essential component, an acrylic (or methacrylic) ester copolymer (A). The acrylic (or methacrylic) ester copolymer (A) is obtained by polymerizing 5 to 70 parts by weight of a monomer mixture (A2m) comprising 40 to 100% by weight of an acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight, in the presence of 100 parts by weight of a copolymer (A1) comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total monomer mixture (A1) is regarded as 100% by weight. In the invention, the wording “acrylic (or methacrylic) ester” means “acrylic aster” and/or “methacrylic ester”.

The copolymer (A1) is a copolymer comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total monomer mixture (A1) is regarded as a basis (100% by weight).

Anacrylic (ormethacrylic) estermonomer (a1m) giving the acrylic (or methacrylic) ester monomer units (a1) capable of forming a homopolymer having a glass transition temperature of −20° C. or lower, is not particularly limited. Examples thereof include ethyl acrylate (the glass transition temperature of a homopolymer thereof, which will be abbreviated to Tg hereinafter: −24° C.), propyl acrylate (Tg:−37° C.), butyl acrylate (Tg:−54° C.), sec-butyl acrylate (Tg:−22° C.), heptyl acrylate (Tg:−60° C.), hexyl acrylate (Tg:−61° C.), octyl acrylate (Tg:−65° C.), 2-ethylhexyl acrylate (Tg:−50° C.), 2-methoxyethyl acrylate (Tg:−50° C.), 3-methoxypropyl acrylate (Tg:−75° C.), 3-methoxybutyl acrylate (Tg:−56° C.), 2-ethoxymethyl acrylate (Tg:−50° C.), octyl methacrylate (Tg:−25° C.), and decyl methacrylate (Tg:−49° C.) . About the acrylic (or methacrylic) ester monomer (a1m), one kind thereof may be used alone or two, more kinds thereof may be used in combination.

The acrylic (or methacrylic) ester monomer (a1m) is used for polymerization so as to set the amount of the monomer units (a1) derived therefrom in the copolymer (A1) into the range from 80 to 99.9% by weight, preferably from 85 to 99.5% by weight, when the weight of the total copolymer (A1) is regarded as a basis (100% by weight). If the used amount of the acrylic (or methacrylic) ester monomer (alm) is too small, the pressure-sensitive adhesive property of the thermally conductive pressure-sensitive adhesive composition obtained therefrom falls near room temperature.

A monomer (a2m) giving the monomer units (a2), which have an organic acid group, is not particularly limited, the typical examples thereof include monomers having a carboxylic acid group, an acid anhydride group, a sulfonic acid group, or some other organic acid group. Besides these, a monomer having a sulfenic acid group, a sulfinic acid group, or a phosphoric acid group may also be used.

Specific examples of the monomer having a carboxylic acid group include α, β-unsaturated monocarboxylic acids such as acrylic acid, methacrylic acid, and crotonic acid; α,β-unsaturated polycarboxylic acids such as itaconic acid, maleic acid, and fumaric acid; and α,β-unsaturated polycarboxylic acid partially-esterified products such as methyl itaconate, butyl maleate, and propyl fumarate. Similarly, the following can be used: a monomer having a group from which a carboxyl group can be derived by hydrolysis or the like, such as maleic anhydride or itaconic anhydride.

Specific examples of the monomer having a sulfonic acid group include α,β-unsaturated sulfonic acids, such as allysulfonic acid, methacrylsulfonic acid, vinylsulfonic acid, styrenesulfonic acid, and arylamide-2-methylpropanesulfonic acid; and salts thereof.

Among these monomers which have an organic acid group, monomers having a carboxyl group are preferred, and acrylic acid and methacrylic acid are particularly preferred. These are preferred since they are industrially inexpensive and easily available, and are well copolymerizable with the other monomer components from the viewpoint of productivity. About the monomer (a2m) which has an organic acid group, one kind thereof may be used alone, two or more kinds thereof may be used in combination.

The monomer (a2m), which has an organic acid group, is used so as to set the amount of the monomer units (a2) derived therefrom in the copolymer (A1) into the range from 0.1 to 20% by weight, preferably from 0.5 to 15% by weight, when the weight of the total copolymer (A1) is regarded as a basis (100% by weight). If the used amount of the monomer (a2m) is too large, the viscosity increases remarkably when the monomer is polymerized, so that the product is solidified. Thus, the polymer is not easily handled.

The monomer unit (a2), which has an organic acid group, is easily introduced into the copolymer by polymerizing the monomer (a2m), which has the organic acid group, as described above. However, the organic acid group may be introduced by a known polymer reaction after the production of the copolymer.

The copolymer (A1) may contain 10% or less by weight of the monomer units (a3), which are derived from a monomer (a3m) containing a group other than any organic acid group.

Examples of the functional group other than any organic acid group include hydroxyl, amino, amide, epoxy, and mercapto groups. Examples of a hydroxyl-group-containing monomer include hydroxyalkyl acrylates or methacrylates, such as hydroxyethyl acrylate (or methacrylate), and hydroxypropyl acrylate (or methacrylate).

Examples of an amino-group-containing monomer include N,N-dimethylaminomethyl acrylate (or methacrylate), N,N-dimethylaminoethyl acrylate (or methacrylate), and aminostyrene. Examples of an amide-grouop-containing monomer include α,β-unsaturated carboxylic acid amides such as acrylamide, methacrylamide, N-methylolacrylamide, N-methylolmethacrylamide, and N,N-dimethylacrylamide.

Examples of an epoxy-group-containing monomer include glycidyl acrylate (or methacrylate), and allyl glycidyl ether. Examples of a mercapto-group-containing group include 2-mercaptoethyl acrylate (or methacrylate). About the monomer (a3m), which contains a functioning group other than any organic acid group, one kind thereof may be used alone, two or more kinds thereof may be used in combination.

Themonomer (a3m), which contains a functioning group other than any organic acid group, is used for polymerization so as to set the amount of the monomer units (a3) derived therefrom in the copolymer (A1) to 10% or less by weight, when the weight of the total copolymer (A1) is regarded as a basis (100% by weight) . If the used amount of the monomer (a3m) is too large, the viscosity increases remarkably when the monomer is polymerized, so that the product is solidified. Thus, the polymer is not easily handled.

The copolymer (A1) may contain, besides the above-mentioned monomer units (a1), (a2) and (a3), the monomer units (a4), which are derived from a monomer (a3m) copolymerizable with these monomers. About the monomer (a3m), one kind thereof may be used alone, two or more kinds thereof may be used in combination. The amount of the monomer units (a4), which are derived from the monomer (a3m), in the copolymer (A1) is 10% or less by weight, preferably 5% or less by weight, when the weight of the total of the copolymer (A1) is regarded as a basis (100% by weight).

The monomer (a3m) is not particularly limited, and specific examples thereof include acrylic (or methacrylic) esters monomers other than the acrylic (or methacrylic) ester monomer (a1m), which is capable of forming a homopolymer which becomes −20° C. or less, α,β-unsaturated polycarboxylic acid completely-esterifiedproducts, alkenylaromaticmonomers, conjugated diene monomers, non-conjugated diene monomers, vinyl cyanide monomers, and carboxylic acid unsaturated-alcohol-esterified products, and olefin monomers.

Specific examples of the acrylic (or methacrylic) ester monomers other than the acrylic (or methacrylic) ester monomer (a1m), which is capable of forming a homopolymer which becomes −20° C. or less, include methyl acrylate (Tg: 10° C.), methylmethacrylate (Tg: 105° C.), ethyl methacrylate (Tg: 63° C.), propyl methacrylate (Tg: 25° C.), and butyl methacrylate (Tg: 20° C.).

Specific examples of the α,β-unsaturated polycarboxylic acid completely-esterified products include dimethyl fumarate, diethyl fumarate, dimethyl maleate, diethyl maleate, and dimethyl itaconate. Specific examples of the alkenyl aromatic monomers include styrene, α-methylstyrene, methyl α-methylstyrene, vinyltoluene, and divinylbenzene.

Specific examples of the conjugated diene monomers include 1, 3-butadiene, 2-methyl-1, 3-butadiene, 1,3-pentandiene, 2,3-dimethyl-1,3-butadiene, 2-chloro-1,3-butadiene, and cyclopentadiene. Specific examples of the non-conjugated diene monomers include 1,4-hexadiene, dicyclopentadiene, and ethylidenenorbornene.

Specific examples of the vinyl cyanide monomers include acrylonitrile, methacrylonitrile, α-chloroacrylonitrile, and α-ethylacrylonitrile. Specific examples of the carboxylic acid unsaturated-alcohol-esterified monomers include vinyl acetate. Specific examples of the olefin monomers include ethylene, propylene, butene, and pentene.

Theweight-averagemolecularweight (Mw) of the copolymer (A1) is measured by gel permeation chromatography (GPC) using polystyrene standard, and is preferably from 100,000 to 400,000, in particular preferably from 150,000 to 300,000.

The copolymer (A1) can be obtained by copolymerizing the monomers (a1m) and (a2m) and the optional monomers (a3m) and (a3m). The method for the polymerization is not particularly limited, and may be solution polymerization, emulsion polymerization, suspension polymerization, and bulk polymerization, or any other polymerization. The method is preferably solution polymerization, and is in particular preferably solution polymerization using, as a polymerizing solvent, a carboxylic acid ester such as ethyl acetate or ethyl lactate, or an aromatic solvent such as benzene, toluene or xylene. In the polymerization, the monomers maybe separately added to a polymerizing reactor. Preferably, the total amount of the monomers may be added thereto at a time.

The method for initiating the polymerization is not particularly limited. Preferably, a thermal polymerization initiator (E1) is used as a polymerization initiator. The thermal polymerization initiator (E1) is not particularly limited, and may be any one of a peroxide polymerization initiator and an azo compound polymerization initiator.

Examples of the peroxide polymerization initiator include hydroperoxides such as t-butylhydroperoxide; peroxides such as benzoylperoxide, and cyclohexanone peroxide; and persulfates such as potassium persulfate, sodium persulfate, and ammonium persulfate. These peroxide polymerization initiators can each be suitably combined with a reducing agent so as to be used as a redox catalyst.

Examples of the azo compound polymerization initiator include 2,2′-azobisisobutyronitrile, 2,2′-azobis(2,4-dimethylvaleronitrile), and 2,2′-azobis(2-methylbutyronitrile). The used amount of the thermal polymerization initiator (E1) is not particularly limited, and usually ranges from 0.01 to 50 parts by weight for 100 parts by weight of the monomers. Other conditions for the polymerization of these monomers (such as polymerizing temperature and pressure, and stirring conditions) are not particularly limited.

After the end of the polymerization reaction, the resultant copolymer (A1) is isolated from the polymerizing solvent if necessary. The method for the isolation is not particularly limited. When the polymerization is solution polymerization, the copolymer (A1) can be obtained by putting the polymerization solution under a reduced pressure and thus distilling off the polymerizing solvent.

The acrylic (or methacrylic) ester copolymer (A) used in the invention can be obtained by polymerizing 5 to 70 parts by weight of a monomer mixture (A2m) comprising 40 to 100% by weight of an acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as a basis (100% by weight), in the presence of 100 parts by weight of the copolymer (A1) obtained as described above.

Examples of the acrylic (or methacrylic) ester monomer (a5m), which is capable of forming a homopolymer having a glass transition temperature of −20° C. or lower, include the same acrylic (or methacrylic) ester monomers as exemplified as the acrylic (or methacrylic) ester monomer (a1m), which is used to synthesize the polymer (A1). About the acrylic (or methacrylic) ester monomer (a5m), one kind thereof may be used alone, two or more kinds thereof may be used in combination.

The ratio of the acrylic (or methacrylic) ester monomer (a5m) in the monomer mixture (A2m) is from 40 to 100% by weight, preferably from 60 to 95% by weight, when the total weight of the monomer mixture (A2m) is regarded as a basis (100% by weight). If the ratio of the acrylic (or methacrylic) ester monomer (a5m) is too small, the pressure-sensitive adhesive property or the flexibility of the thermally conductive pressure-sensitive adhesive composition obtained by use of the methacrylic ester copolymer (A) becomes insufficient.

Examples of the monomer (a6m), which has an organic acid group, include the same monomers each having an organic acid group as exemplified as the monomer (a2m) used to synthesize the copolymer (A1). About the monomer (a6m), which has an organic acid group, one kind thereof may be used alone, two or more kinds thereof may be used in combination.

The ratio of the monomer (a6m), which has an organic acid group in the monomer mixture (A2m), is from 0 to 60% by weight, preferably from 5 to 40% by weight, when the total weight of the monomer mixture (A2m) is regarded as a basis (100% by weight) . If the ratio of the monomer (a6m), which has an organic acid group, is too large, the hardness of the thermally conductive pressure-sensitive adhesive composition obtained by use of the copolymer (A) rises. In particular, the pressure-sensitive adhesive property thereof at a high temperature (100° C.) falls.

Examples of the monomer (a7m), which is copolymerizable with the monomer (a5m) and the monomer (a6m) described above, include the same monomers as exemplified as the monomer (a3m) or the monomer (a3m) used to synthesize the polymer (A1).

As the copolymerizable monomer (a7m), a polyfunctional monomer having two or more polymerizable unsaturated bonds can be used. The copolymerization of the polyfunctional monomer makes it possible to introduce intramolecular and/or intermolecular crosslinks into the copolymer to make the adhesive force thereof as a pressure-sensitive adhesive high.

As the polyfunctional monomer, the following can be used: a polyfunctional acrylate (or methacrylate) such as 1,6-hexanediol diacrylate or dimethacrylate, 1,2-ethylene glycol diacrylate or dimethacrylate, 1,12-dodecanediol diacrylate or dimethacrylate, polyethylene glycol diacrylate or dimethacrylate, polypropylene glycol diacrylate or dimethacrylate, neopentyl glycol diacrylate or dimethacrylate, pentaerythritol diacrylate or dimethacrylate, trimethylolpropane triacrylate or trimethacrylate, pentaerythritol triacrylate or trimethacrylate, ditrimethylolpropane triacrylate or trimethacrylate, pentaerythritol tetraacrylate or tetramethacrylate, or dipentaerythritol hexaacrylate or hexamethacrylate; a substituted triazine such as 2,4-bis(trichloromethyl)-6-p-methoxystyrene-5-triazine ; or a monoethylene-based unsaturated aromatic ketone such as 4-acryloxybenzophenone.

The amount of the monomer mixture (A2m) is preferably from 5 to 70 parts by weight, preferably from 10 to 50 parts by weight for 100 parts by weight of the copolymer (A1). If the amount of the monomermixture (A2m) is too small, the acrylate (or methacrylate) ester copolymer (A) and the metal hydroxide (B) cannot be homogeneously mixed, so that the thermal conductivity and other properties of the thermally conductive sheet-form molded foam to be obtained fall. On the other hand, if the amount of the monomer mixture (A2m) is too large, the polymerization reaction does not advance sufficiently, that cause problems such as a bad smell of unreacted ones out of the monomers in the thermally conductive sheet-form molded foam to be obtained.

Conditions for polymerizing the monomer mixture (A2m) in the presence of 100 parts by weight of the copolymer (A1) are not particularly limited except the method for initiating the polymerization. The polymerization can be conducted under the same conditions as synthesizing the copolymer (A1) . In the invention, the method for initiating the polymerization for polymerizing the monomer mixture (A2m) in the presence of the copolymer (A1) is to use the thermal polymerization initiator (E2). If a photopolymerization initiator is used instead of the thermal polymerization initiator, the adhesive force of a foamed sheet made from the thermally conductive pressure-sensitive adhesive composition to be obtained is deteriorated.

Examples of the thermal polymerization initiator (E2) include the same thermal polymerization initiators as exemplified as the polymerization initiator (E1) used to synthesize the copolymer (A1) . Among these, preferred are initiators whose one-minute half-value period temperature is 120° C. or higher and 170° C. or lower. The used amount of the thermal polymerization initiator (E2) is not particularly limited, and usually ranges from 0.1 to 50 parts by weight for 100 parts by weight of the monomer mixture (A2m).

The polymerization conversion ratio of the monomer mixture (A2m) is preferably 95% or more by weight. If the polymerization conversion ratio is too low, monomer odor unfavorably remains in the thermally conductive sheet-form molded foam to be obtained.

The thermally conductive pressure-sensitive adhesive composition of the invention has the acrylic (or methacrylic) estercopolymer (A) and a metal hydroxide (B), wherein the acrylic (or methacrylic) ester copolymer (A) is foamed.

Examples of the metal hydroxide (B) include lithium hydroxide, sodium hydroxide, potassium hydroxide, beryllium hydroxide, magnesium hydroxide, calcium hydroxide, strontium hydroxide, barium hydroxide, iron hydroxide, zinc hydroxide, aluminum hydroxide, gallium hydroxide, and indium hydroxide. The hydroxide (B) is preferably a hydroxide of any metal in Group II or XIII in the periodic table.

Examples of the metal in Group II include magnesium, calcium, strontium, and barium. Examples of the metal in Group XIII include aluminum, gallium, and indium. About the metal hydroxide (B), a single kind thereof may be used alone, two or more kinds thereof may be used in combination. The use of the metal hydroxide (B) makes it possible to give thermal conductivity and excellent flame resistance to the thermally conductive pressure-sensitive adhesive composition of the invention.

The shape of the metal hydroxide (B) is not particularly limited, and may be any one selected from spherical, needle, fibrous, scaly, twig, planar and indeterminate forms. Among the above-mentioned examples of the metal hydroxide (B), aluminum hydroxide is particularly preferred. The use of aluminum hydroxide makes it possible to give excellent thermal conductivity and particularly excellent flame resistance to the thermally conductive pressure-sensitive adhesive composition of the invention.

Usually, the particle diameter of the spherical metal hydroxide (B) is preferably from 0.2 to 150 μm, more preferably from 0.7 to 100 μm. The average particle diameter of the spherical metal hydroxide (B) is preferably from 1 to 80 μm. If the average particle diameter is too small, the viscosity of the thermally conductive pressure-sensitive adhesive composition increases so that the acrylic (or methacrylic) ester copolymer and the metal hydroxide (B) may not be kneaded at ease. Simultaneously, the hardness also increases so that the shape-conformability of the thermally conductive sheet-form molded foam therefrom may be made lower.

On the other hand, if the average particle diameter is too large, the thermally conductive pressure-sensitive adhesive composition or the thermally conductive sheet-form molded foam becomes too soft so that the composition may undergo excessive pressure-sensitive adhesion, the adhesive property may lower at high temperature or the foam may be thermally deformed at high temperature.

In the invention, the used amount of the metal hydroxide (B) ranges from 70 to 170 parts by weight for 100 parts by weight of the acrylic (or methacrylic) ester copolymer (A) . If the used amount of the metal hydroxide (B) is too small, there are caused a problem about high-temperature adhesive force, a problem of a decrease in the thermal conductivity, and other problems. Conversely, if the amount is too large, the hardness increases to cause a problem of a decrease in the shape-conformability.

The thermally conductive pressure-sensitive adhesive composition of the invention is characterized in that the acrylic (or methacrylic) ester copolymer (A) is foamed. The foaming multiplying factor thereof is not particularly limited, and is preferably from 1.05 to 1.4 times. When the foaming multiplying factor is within this range, the thermally conductive pressure-sensitive adhesive composition, which can be obtained, is excellent in the balance between hardness and pressure-sensitive adhesive property, and in shape-conformability.

The method for the foaming is not particularly limited. Thus, various methods can be used. Examples thereof include a method (1) of taking air in the atmosphere into a toffee-like viscous mixture produced by mixing the copolymer (A1), the monomer mixture (A2m), and the metal hydroxide (B) by stirring the mixture; a method (2) of blowing a gas such as nitrogen into the mixture; a method (3) of taking, into the mixture, a fluid having a low compatibility with the copolymer (A1) and the monomer mixture (A2m), such as water, in a fine particle form by stirring the mixture; a method (4) of generating a fluid dissolving in the viscous mixture in an air foam or liquid foam form by reducing the pressure or heating the mixture; a method (5) of mixing an optically-decomposable foaming agent, which can be decomposed by light, then radiating light to the resultant; and a method (6) of mixing a thermally-decomposable foaming agent, which can be decomposed by heat, then heating the resultant. In the invention, it is preferred to perform the foaming by use of a foaming agent, in particular, a foaming agent which can be decomposed by heat so as to generate gas (thermally-decomposable foaming agent).

Examples of the thermally-decomposable foaming agent include p,p′-oxybis (benzenesulfonylhydrazide), and azodicarboamide. The used amount of the foaming agent is preferably from 0.1 to 3 parts by weight, more preferably from 0.3 to 2 parts by weight for 100 parts by weight of the acrylic (or methacrylic) ester copolymer (A). When the used amount of the foaming agent is selected in this manner, the foaming multiplying factor can be adjusted into a preferred range so as to yield a thermally conductive pressure-sensitive adhesive composition excellent in the balance between hardness and pressure-sensitive adhesive property, and in shape-conformability.

The thermally conductive sheet-form molded foam which has the thermally conductive pressure-sensitive adhesive composition of the invention, the foam being used in an electronic parts or the like, easily gives a sheet high sheet-smoothness; and when the foam is used for a long period, sedimentation or separation of pigment and a filler therein is easily prevented. For this, it is necessary that the foam has a high yield value in a low shear rate range. In order to make the yield value high, it is preferred to add what is a so-called “gelatinizer” to the thermally conductive pressure-sensitive adhesive composition of the invention.

In the thermally conductive pressure-sensitive adhesive composition of the invention, it is preferred to use silica having a specific property as the gelatinizer in order to improve both of the sheet-smoothness and mold-formability of the thermally conductive sheet-form molded foam.

As this silica, which has a specific property, in the invention there can be used silica (C) comprising primary particles having an average particle diameter of 5 to 20 nm and having a hydrophobicity ratio of 50% or less when it is based on a transmissivity method.

The silica (C), which is used in the invention, comprises primary particles having an average particle diameter of 5 to 20 nm. If the average particle diameter of the primary particles is too small, the handleability of the thermally conductive pressure-sensitive adhesive composition is lowered inappropriately. If the average particle diameter of the primary particles is too large, secondary aggregates are unfavorably generated at ease.

The average particle diameter of the primary particles in the silica (C) is obtained, using a particle diameter distribution curve prepared from measurement results of the primary average particle diameter observed under an electron microscope and measurement results through a light scattering method using a laser ray as a light source.

The silica (C), which is used in the invention, has a hydrophobicity ratio of 50% or less when it is based on a transmissivity method. If the hydrophobic ratio of the silica (C) is too large, heating-fluidization of the thermally conductive pressure-sensitive adhesive composition is inappropriately caused. From the viewpoint of sheet-smoothness, in the silica (C) used in the invention, the hydrophobicity ratio based on the transmissivity method is more preferably 30% or less, in particular preferably 10% or less.

The “hydrophobicity ratio based on a transmissivity method” is measured by the following method.

One gram of silica is collected into a 200-mL separating funnel, and then 100 mL of pure water is added into the separating funnel. Next, the separating funnel is set to a tumbler mixer and the silica is dispersed at 90 rpm for 10 minutes. Furthermore, the separating funnel is allowed to stand still for 10 minutes, and then 20 to 30 mL of the lower phase in the separating funnel is taken out from the funnel. Into a quartz cell is put the 10 mL of the separated liquid taken out from the lower phase, and then the liquid is set to a spectrophotometer, using pure water as a blank. The transmissivity thereof at a wavelength of 500 nm is measured with the spectrophotometer, and is defined as the hydrophobic ratio thereof.

The thermally conductive pressure-sensitive adhesive composition of the invention contains the silica (C) preferably in an amount of 0.1 to 5 parts by weight for 100 parts by weight of the acrylic (or methacrylic) ester copolymer (A), more preferably in an amount of 0.5 to 2 parts by weight therefor. In other words, in the production of the thermally conductive pressure-sensitive adhesive composition of the invention, the silica (C) is desirably used in the state that 100 parts by weight of the whole of the copolymer (A1) and the monomer mixture (A2m) are mixed preferably with 0.1 to 5 parts by weight of the silica (C), more preferably with 0.5 to 2 parts by weight thereof. When the used amount of the silica (C) is in the above-mentioned range, the viscosity of the thermally conductive pressure-sensitive adhesive composition of the invention is kept appropriate and the sheet-smoothness of the thermally conductive sheet-form molded foam of the invention is improved. In the thermally conductive pressure-sensitive adhesive composition of the invention, the viscosity measured at 60° C. with a parallel plate type viscoelastic rheometer (manufactured by Rheometric Scientific Inc.) ranges preferably from 100 to 600 (Pa·s), more preferably form 200 to 400 (Pa·s).

The thermally conductive pressure-sensitive adhesive composition of the invention may comprise a compound (D) having a melting point of 120 to 200° C. and a molecular weight of less than 1000. The compound (D) is present in a solid form at a temperature at which the thermally conductive pressure-sensitive adhesive composition of the invention is ordinarily used as a PDP heat radiating sheet or the like (approximately 100° C. or lower), but the compound (D) is subjected to heating treatment at a temperature of 120 to 200° C., as a treatment when the sheet is recycled or abandoned after used, whereby the compound (D) bleeds out from between the thermally conductive sheet-form molded foam and an adherend onto which the sheet adheres, that is, onto the surface of the thermally conductive sheet-form molded foam so that easy-peeling property is given to the sheet.

The compound (D) is not particularly limited if it is a compound having a melting point of 120 to 200° C. and a molecular weight of less than 1000. If the melting point is too low, at a temperature at which the thermally conductive pressure-sensitive adhesive composition of the invention is ordinarily used as a PDP heat radiating sheet or the like (approximately 100° C. or lower) the sheet is already in a state that the sheet can easily be peeled. Thus, the heat radiating sheet may fall down from the adherend onto which the sheet adheres. On the other hand, if the meting point is too high, the temperature for the heating treatment needs to be higher than 200° C. Thus, the decomposition or seizing of the acrylic (or methacrylic) ester copolymer (A) may be caused so that the peelability may fall. If the molecular weight of the compound (D) is 1000 or more, the viscosity thereof is high even when the temperature thereof reaches the melting point. Accordingly, the compound does not bleed out easily so that the compound does not give easy-peeling property at ease.

The compound (D) is preferably an aliphatic amide compound having a melting point of 120 to 200° C. and a molecular weight of less than 1000. Examples of the compound include methylenebisstearic amide (melting point: 130° C.), ehylenebisstearic amide (melting point: 145° C.), ethylenebislauric amide (melting point: 157° C.), ethylenebiscapricamide (melting point: 161° C.), bisstearic amide (melting point: 137° C.), and bislauric amide (melting point: 143° C.) . These may be used alone or in combination of two or more thereof.

Desirably, the thermally conductive pressure-sensitive adhesive composition of the invention comprises the compound (D) in an amount preferably from 0.05 to 10 parts by weight, more preferably from 0.2 to 8 parts by weight, even more preferably from 0.3 to 5 parts by weight for 100 parts by weight of the acrylic (or methacrylic) ester copolymer (A) . In other words, in the production of the thermally conductive pressure-sensitive adhesive composition of the invention, the compound (D) is desirably used in the state that 100 parts by weight of the whole of the copolymer (A1) and the monomer mixture (A2m) are mixed preferably with 0.05 to 10 parts by weight of the compound (D), more preferably with 0.2 to 8 parts by weight thereof, even more preferably with 0.3 to 5 parts by weight thereof.

When the used amount of the compound (D) is within the above-mentioned range, the easy-peeling property is well expressed and further the adhesive property of the thermally conductive pressure-sensitive adhesive composition can also be kept good at ordinary use temperatures.

The thermally conductive pressure-sensitive adhesive composition of the invention comprises the acrylic (or methacrylic) ester copolymer (A), the metal hydroxide (B), and if necessary, the foaming agent, silica (C) and compound (D) at the above-mentioned ratio therebetween, further, if necessary, the composition can comprise known various additives such as a pigment, a different filler, a different thermal conductivity supplying agent, a flame retardant, an age resistor, a thickener, and a tackifier.

As the pigment, carbon black, titanium dioxide or any other pigment can be used whether it is organic or inorganic. Examples of the different filler include inorganic compounds such as clay. Nano-particles of fullerene, carbon nanotube, or the like may be added.

Examples of the different thermal conductivity supplying agent include inorganic compounds such as boron nitride, aluminum nitride, silicon nitride, aluminum oxide, and magnesium oxide as thermal conductivity supplying agents other than the metal hydroxide.

Examples of the flame retardant include ammonium polyphosphate, zinc borate, tin compounds, organic phosphorus-containing compounds, red phosphorus-based compounds, and silicone-based flame-retardants. Usually, the age resistor is not used since the resistor may probably block radical polymerization. However, if necessary, a polyphenol-based, a hydroquinone-based, a hindered amine-based or some other types of age resistor can be used.

As the thickener, there can be used: acrylic polymer particles, inorganic compound fine particles such as finely particulate silica, and a reactive inorganic compound such as magnesium oxide. Examples of the tackifier include terpene-based resins, terpene phenol-based resins, rosin-based resins, petroleum resins, coumalin-indene resins, phenolic resins, hydrogenated rosin esters, and disproportional rosin esters, and xylene resins.

Furthermore, in order to heighten the coagulation force of the thermally conductive pressure-sensitive adhesive composition of the invention as a pressure-sensitive adhesive and improve the heat resistance thereof and so on, an external crosslinking agent may be added to the composition so as to introduce a crosslinked structure into the copolymer.

Examples of the external crosslinking agent include polyfunctional isocyanate crosslinking agents such as tolylene diisocyanate, trimethylolpropane diisocyanate, and diphenylmethane triisocyanate; epoxy crosslinking agents such as diglycidyl ether, polyethylene glycol diglycidyl ether, and trimethylolpropane triglycidyl ether; melamine resin crosslinking agents; amino resin crosslinking agents; metal salt crosslinking agents; metal chelate crosslinking agents; and peroxide crosslinking agents.

The external crosslinking agent is an agent which is added to the acrylic (or methacrylic) ester copolymer (A) obtained and then subjected to heat treatment or radial ray radiating treatment, thereby forming intramolecular and/or intermolecular crosslinks in molecules of the acrylic (or methacrylic) ester copolymer (A).

The method for obtaining the thermally conductive pressure-sensitive adhesive composition of the invention from the acrylic (or methacrylic) ester copolymer (A), the metal hydroxide (B), the optionally-used foaming agents, silica (C) and compound (D), and so on is not particularly limited. The method may be a method of mixing and foaming the acrylic (or methacrylic) ester copolymer (A), the metal hydroxide (B) and the others that have been synthesized separately from each other. Preferred is a method of mixing the metal hydroxide (B) and the others with the acrylic (or methacrylic) ester copolymer (A) immediately before the acrylic (or methacrylic) ester copolymer (A) is synthesized and foamed since the acrylic (or methacrylic) ester copolymer (A), the metal hydroxide (B) and the others can be homogeneously mixed.

In the case of adopting the method of mixing the metal hydroxide (B) and the others with the acrylic (or methacrylic) ester copolymer (A) separately synthesized, and foaming the mixture, the method for the mixing is not particularly limited and may be a dry mixing method of mixing the acrylic (or methacrylic) ester copolymer (A) dried with the metal hydroxide (B) with a roll, a Henschel mixer, a kneader or the like, or a wet mixing method of mixing them in the presence of an organic solvent in a container equipped with a stirrer.

In the case of adopting the method of mixing the metal hydroxide (B) and the others with the acrylic (or methacrylic) ester copolymer (A) immediately before the acrylic (or methacrylic) ester copolymer (A) is synthesized and foamed, it is preferred to yield a mixture of the copolymer (A1), the monomer mixture (A2m), the thermal polymerization initiator (E2), the metal hydroxide (B), and the optionally-used foaming agent, silica (C), compound (D) and other components, and subsequently foam and heat the mixture under conditions for the polymerization. At this time, the order that the respective components are mixed is not particularly limited. It is preferred to perform the mixing at such a temperature that the polymerization of the monomer mixture (A2m) does not advance.

The thermally conductive pressure-sensitive adhesive composition of the invention is made into a sheet, whereby a thermally conductive sheet-form molded foam can be produced. The thermally conductive sheet-form molded foam may be a molded foam made only of the thermally conductive pressure-sensitive adhesive composition or may be a composite composed of a substrate and one or more layers made of the thermally conductive pressure-sensitive adhesive composition and formed on a single surface or both surfaces of the substrate.

The thickness of the layer(s) made of the thermally conductive pressure-sensitive adhesive composition in the thermally conductive sheet-form molded foam of the invention is not particularly limited, and is usually from 50 μm to 3 mm. If the thickness of the layer(s) of the thermally conductive pressure-sensitive adhesive composition is too thin, air is easily involved in the molded foam(s) when the molded foam(s) adhere(s) onto a heat generating body and a heat radiating body. As a result, a sufficient thermal conductivity may not be obtained. On the other hand, if the thickness of the layer(s) of the thermally conductive pressure-sensitive adhesive composition is too thick, the thermal resistance of the sheet becomes large so that the heat radiating property may be deteriorated.

In the case of forming one or more layers made of the thermally conductive pressure-sensitive adhesive composition onto a single surface or both surfaces of the substrate, the substrate is not particularly limited. Specific examples thereof include a foil-form product of a metal or alloy excellent in thermal conductivity, such as aluminum, copper, stainless steel, or beryllium copper; a sheet-form product made of a polymer which has an excellent thermal conductivity in itself, such as thermally conductive silicone; a thermally conductive plastic film into which a thermally conductive filler is incorporated; various nonwoven clothes; a glass cloth; and a honeycomb structure. As the plastic film in the above-mentioned thermally conductive plastic film, the following can be used: a film made of a heat-resisting polymer such as polyimide, polyethylene terephthalate, polyethylene naphthalate, polytetrafluoroethylene, polyetherketone, polyethersulfone, polymethylpentene, polyetherimide, polysulfone, polyphenylenesulfide, polyamideimide, polyesterimide, and aromatic polyamide.

The method for producing the thermally conductive sheet-form molded foam from the thermally conductive pressure-sensitive adhesive composition is not particularly limited. For example, it is advisable to apply the thermally conductive pressure-sensitive adhesive composition onto a process sheet subjected to releasing treatment, such as a polyethylene film. Or, it is advisable to cause the thermally conductive pressure-sensitive adhesive composition, which may be optionally sandwiched between two process sheets subjected to releasing treatment, to pass between rolls, thereby making the composition into a sheet. When the composition is extruded from an extruder, the composition is caused to pass through a dice to control the thickness.

For example, when the thermally conductive pressure-sensitive adhesive composition is applied onto a single surface or both surfaces of a substrate and the resultant is heated by/with hot wind, an electric heater, infrared rays or the like, a thermally conductive sheet-form molded foam can be obtained which is composed of the substrate and one or more layers made of the thermally conductive pressure-sensitive adhesive composition and formed on the single surface or both the surfaces of the substrate. The thermally conductive pressure-sensitive adhesive composition of the invention can be supplied as a part of an electronic parts by forming a thermally conductive sheet-form molded foam therefrom directly on a substrate such as a heat radiating body.

The thermally conductive sheet-form molded foam of the invention can be appropriately obtained by a production process comprising which comprises:

the step of mixing 100 parts by weight of a copolymer (A1) comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total monomer mixture (A1) is regarded as 100% by weight, 5 to 70 parts by weight of a monomer mixture (A2m) comprising 40 to 100% by weight of an acrylic (or methacrylic) ester monomer (aSm) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight, a thermal polymerization initiator (E2) in an amount of 0.1 to 50 parts by weight for 100 parts by weight of the monomer mixture (A2m), a metal hydroxide (B) in an amount of 70 to 170 parts by weight for 100 parts by weight of the total of the copolymer (A1) and the monomer mixture (A2m), thereby forming a mixture (F); the stepof foaming themixture (F); the stepofheating the mixture (F); and the step of making the mixture (F) into a sheet.

According to this process, only the heating treatment makes it possible to attain the performance having both of high-temperature adhesive property of a thermally conductive sheet-form molded foam made of a thermally conductive pressure-sensitive adhesive composition and pressure-sensitive adhesive property thereof over wide temperatures ranging from low temperature to high temperature, the performance not having been obtained at ease hitherto without using the combination of photopolymerization and optical crosslinking.

The step of the foaming the mixture (F) is preferably a step of foaming the mixture (F) to set the foaming multiplying factor thereof into the range of 1.05 to 1.4 times.

The mixture (F), which is formed by mixing the copolymer (A1), the monomer mixture (A2m), the thermal polymerization initiator (E2) and the metal hydroxide (B), may be a mixture (G) wherein a compound (D) having a melting point of 120 to 200° C. and a molecular weight of less than 1000 is further mixed therewith. Desirably, the compound (D) is mixed preferably in an amount of 0.05 to 10 parts by weight, more preferably in an amount of 0.2 to 8 parts by weight, even more preferably in an amount of 0.3 to 5 parts by weight with 100 parts by weight of the whole of the copolymer (A1) and the monomer mixture (A2m).

The mixture (F) may be a mixture (G′) wherein an aliphatic amide compound having a melting point of 120 to 200° C. and a molecular weight of less than 1000 is further mixed therewith. The aliphatic amide compound is mixed at the same ratio as the compound (D).

The mixture (F), the mixture (G) or the mixture (G′) may be a mixture wherein silica (C) comprising primary particles having an average particle diameter of 5 to 20 nm and having a hydrophobicity ratio of 50% or less when it is based on a transmissivity method, is further mixed therewith. Desirably, the silica (C) is mixed preferably in an amount of 0.1 to 5 parts by weight, more preferably in an amount of 0.5 to 2 parts by weight with 100 parts by weight of the whole of the copolymer (A1) and the monomer mixture (A2m).

In the above-mentioned process for producing a thermally conductive sheet-form molded foam, the metal hydroxide (B) is preferably aluminum hydroxide.

At this time, it is allowable to mix the copolymer (A1), the monomer mixture (A2m), the thermal polymerization initiator (E2), the metal hydroxide (B) and an optionally-used foaming agent while heating them, so as to form the mixture (F), foam this mixture, and subsequently make the resultant mixture into a sheet (this method being referred to as the “process (I)”). It is preferred to mix the copolymer (A1), the monomer mixture (A2m), the thermal polymerization initiator (E2), the metal hydroxide (B) and an optionally-used foaming agent so as to form the mixture (F), foam this mixture, and heat the mixture at the same time when the mixture is made into a sheet (this process being referred to as the “process II”). In the process (II), the foaming may be performed at the same time when the mixture is made into a sheet while heated, or may be performed without the mixture being heated before the mixture is made into a sheet.

In the process (I), the copolymer (A1), the monomer mixture (A2m), the thermal polymerization initiator (E2), the metal hydroxide (B), and an optionally-used foaming agent are mixed while heated, so as to form the mixture (F). This mixture is foamed, and subsequently the resultant thermally conductive pressure-sensitive adhesive composition, wherein the acrylic (or methacrylic) ester copolymer (A) and the metal hydroxide (B) are homogeneously mixed and foamed, is made into a sheet.

The method for the mixing is not particularly limited. Preferably, a powerful mixer is used in order to conduct the polymerization of the copolymer (A1) and the monomer mixture (A2m) and ensure homogeneous mixing of the resultant acrylic (or methacrylic) ester copolymer (A) and the metal hydroxide (B). The mixing may be performed in a batch system, or may be continuously performed. The order that the respective components are mixed is not particularly limited.

Examples of the mixer for the batch system include kneaders or stirring machines for high-viscosity materials, such as a pulverizer, a kneader, an internal mixer, and a planetary mixer. Examples of the mixer for the continuous system include a Farrel type continuously-kneading machine wherein a rotor is combined with a screw, a screw-equipped kneading machine having a specific structure, an monoaxial extruder and a biaxial extruder that have been used for extrusion. About the extruders and the kneaders, two or more kinds thereof may be combined, or the same type machines may be used in the state that they are linked. Among these, the biaxial extruder is particularly preferred from the viewpoint of the continuity and shear rate thereof.

The heating temperature needs to be a temperature at which the polymerization and the foaming advance smoothly. Usually, the temperature is preferably from 100 to 200° C., more preferably from 120 to 160° C. The atmosphere at the time of the heating and the mixing is not particularly limited if the atmosphere allows radical polymerization to advance. The method for making a sheet form of the thermally conductive pressure-sensitive adhesive composition obtained by the heating and the mixing is not particularly limited, and examples thereof include a method of causing the composition sandwiched between process sheets to pass between rolls, and a method of causing the composition to pass through a dice when the composition is extruded from a kneader.

In the process (II), the copolymer (A1), the monomer mixture (A2m), the thermal polymerization initiator (E2), the metal hydroxide (B), and an optionally-used foaming agent are mixed, and subsequently this mixture is foamed, and the mixture is made into a sheet at the same time when the mixture is heated. The foaming may be performed at the same time when the mixture is made into a sheet while heated, or may be performed before the mixture is made into a sheet without heating the mixture.

The mixer for preparing the mixture may be the same as used in the process (I). The order that the respective components are mixed is not particularly limited. The temperature when the respective components are mixed is set to 60° C. or lower. If the components are mixed at a temperature higher than 60° C., the polymerization of the monomer mixture (A2m) initiates during the mixing, so that the viscosity rises. Thus, subsequent operations become difficult.

Next, the mixture of the respective components is foamed, and further the mixture is made into a sheet at the same time when the mixture is heated. In the case of performing the foaming at the same time of the heating and the sheet-formation, the heating causes foaming due to the thermally-decomposable foaming agent to advance in accordance with the polymerization of the copolymer (A1) and the monomer mixture (A2m) and conditions therefor. When the sheet-formation is performed at the same time, a thermally conductive sheet-form molded foam is formed. In the case of foaming the mixture without heating the mixture before the sheet-formation, the foaming is performed by means of a means other than the foaming by use of the thermally-decomposable foaming agent before the sheet-formation.

The heating temperature is preferably from 100 to 200° C., more preferably from 120 to 160° C. If the heating temperature is too low, the polymerization reaction of the monomer mixture (A2m) does not advance sufficiently that may cause problems such that odor by unreacted ones out of the monomers is generated. If the heating temperature is too high, appearance defects such as a color tone change based on what is called “burning” may be generated in the thermally conductive sheet-formmolded foam to be obtained.

At the time of the sheet-formation, the composition is desirably pressed to make the thickness thereof even. About conditions for the pressing, the pressure is set usually to 10 MPa or less, preferably to 1 MPa or less. If the composition is pressed at a pressure more than 10 MPa, the foamed cells may be unfavorably broken. About the time for the pressing, the optimal point thereof should be selected in accordance with the temperature conditions, the kind and amount of the polymerization initiator to be used, and others, and is preferably one hour or less, considering productivity and so on.

### EXAMPLES

### Examples and Comparative Examples

The invention will be described in more detail by way of the following examples. In the examples, “parts” and “%” are “parts by weight” and “% by weight” unless otherwise specified.

Methods for evaluating properties of an acrylic (or methacrylic) ester copolymer (A), a thermally conductive sheet-form molded foam, and a thermally conductive foamed sheet are as follows.

(1) The weight-average molecular weight (Mw) and the number-average molecular weight (Mn) of an acrylic (or methacrylic) ester copolymer (A)

The weight-average molecular weight (Mw) and the number-average molecular weight (Mn) of an acrylic (or methacrylic) ester copolymer (A) were obtained in terms of standard polystyrene by gel permeation chromatography using tetrahydrofuran as a developing solvent.

(2) The foaming multiplying factor of a thermally conductive sheet-form molded foam

The value obtained by dividing the volume per unit weight of a thermally conductive sheet-form molded foam by the volume per unit weight of a thermally conductive sheet-form molded body which had the same composition and was not foamed was defined as the foaming multiplying factor of the thermally conductive sheet-form molded foam.

(3) The hardness of a thermally conductive sheet-form molded foam

The hardness of a thermally conductive sheet-form molded foam was determined by the Society of Rubber Industry, Japan Standard (SRIS), ASKER C method.

(4) The thermal conductivity of a thermally conductive sheet-form molded foam

The thermal conductivity of a thermally conductive sheet-form molded foam was obtained by measurement with a thermal conductivity rapidly-measuring device (QTM-500, manufactured by Kyoto Electronics Manufacturing Co., Ltd.) at room temperature.

(5) The room-temperature adhesive force of a thermally conductive sheet-form molded foam

A 25 mm×125 mm test piece was superpose on an aluminum plate, and the resultant was pressed with 2-kg rollers to bond and was then allowed to stand still for one hour. This sample was set into a thermostat bath, the temperature of which was set. The maximum adhesive strength in a 90-degree direction was measured at a tensile rate of 50 mm/minute. This value was defined as the room-temperature adhesive force of the thermally conductive sheet-form molded foam.

(6) The high-temperature adhesive force of a thermally conductive sheet-form molded foam

The high-temperature adhesive force of a thermally conductive sheet-form molded foam was obtained in the same way as in the test for the room-temperature adhesive force except that the temperature of the thermostat bath was set to 100° C.

(7) The shape-conformability of a thermally conductive sheet-form molded foam

A glass plate was put onto a 50 mm×100 mm test piece, and a stress of 20 g/cm² (1.96×10³ Pa) was applied to the glass plate for 30 seconds. The stress was removed, and the resultant was conditioned for 3 days. Thereafter, the ratio of the area adhered closely to the glass surface was measured. From this value, the shape-conformability of the thermally conductive sheet-form molded foam was evaluated. As this value is larger, the shape-conformability is better.

(8) Flame resistance

A test was made in accordance with the UL standard UL94 “TESTS FOR FLAMMABILITY OF PLASTIC MATERIALS FOR PARTS IN DEVICES”, so as to evaluate flame resistance. Flame was brought into contact with a sample in a stripe form for 10 seconds. Immediately after lingering flame burning stopped, second flame was again brought into contact with the same sample for 10 seconds. The sample was evaluated about test items shown in Table 1. The test was made about five samples per the same test kinds. Based on the results, classification into burning classes shown in Table 1 was performed.

Table 1

TABLE 1

| Classification in | | | |
|---|---|---|---|
| Burning Class | UL94 V-0 | UL94 V-1 | UL94 V-2 |
| Maximum value of | ≦10 seconds | ≦30 seconds | ≦30 seconds |
| lingering flame | | | |
| burning times | | | |
| Total value of the sums | ≦50 seconds | ≦250 seconds | ≦250 seconds |
| of lingering flame | | | |
| burning times after | | | |
| the First and Second | | | |
| flame-contacts | | | |
| Maximum value of the | ≦30 seconds | ≦60 seconds | ≦60 seconds |
| sums of lingering | | | |
| flame burning time | | | |
| and non-flame | | | |
| burning time after the | | | |
| Second flame-contact | | | |
| Firing cotton by dropped | Not caused | Not caused | Caused |
| substances | | | |
| Lingering or non-flame | Not caused | Not caused | Not caused |
| burning to the clamp | | | |

In Table 1, the wording “maximum value of lingering flame burning times” is a maximum value out of the respective lingering flame burning times obtained about the five samples of each of the kinds. The wording “total value of the sums of lingering flame burning times after the First and Second flame-contacts” is a total value obtained by totaling the respective sums of the lingering flame burning times obtained about the five samples of each of the kinds. The wording “maximum value of the sums of lingering flame time and non-flame burning time after the Second flame-contact” is a maximum value out of the respective sums of the lingering flame time and the non-flame burning time obtained about the five samples of each of the kinds. The wording “not caused” means that the specified phenomenon was not caused at all in the five samples.

### EXAMPLE 1

Into a reactor was put 100 parts of a monomer mixture composed of 94% of 2-ethylhexyl acrylate and 6% of acrylic acid, 0.03 parts of 2,2′-azobisisobutyronitrile and 700 parts of ethyl acetate, and the monomer mixture was homogeneously dissolved. The reactor was purged with nitrogen, and then polymerization reaction was conducted at 80° C. for 6 hours. The polymerization conversion ratio was 97%. The resultant polymer was dried under reduced pressure to vaporize ethyl acetate, thereby yielding a viscous solid copolymer (A1) (1). The Mw of the copolymer (A1) (1) was 280,000, and the Mw/Mn was 3.1.

Into a mortar for a pulverizer were put 100parts of the copolymer (A1) (1), 44.5 parts of a monomer mixture (A2m) (1) composed of 50.6% of butyl acrylate, 11.2% of methacrylic acid, 33.7% of 2-ethylhexyl acrylate, and 4.5% of polyethylene glycol dimethacrylate (the recurring number of oxyethylene chains: approximately 23, NK ESTER 23G, manufactured by Shin-Nakamura Chemical Corp. (polyethylene glycol # 1000 dimethacrylate)) (hereinafter abbreviated as “PEGDMA”), 1.6 parts of 1,1-bis(t-butylperoxy)-3,3,5-trimethylcyclohexanone (hereinafter, abbreviated as “TMCH”) [temperature of one-minute half-value period: 149° C.], 1.0 part of p,p′-oxybis(benzenesulfonylhydrazide) (hereinafter abbreviated as “OBSH”), which is a thermally-decomposable foaming agent, and 200 parts of aluminum hydroxide all together at once. The components were sufficiently mixed in a pulverizer at room temperature. At this time, the ratio by weight of the aluminum hydroxide to 100 parts of the total of the copolymer (A1) (1) and the monomer mixture (A2m) was 138 parts. Thereafter, the mixture was defoamed while stirring under reduced pressure, so as to yield a viscous liquid sample. A polyester film applied with a releasing agent was laid onto the bottom surface of a mold of 400 mm long, 400 mm wide and 2 mm deep, and then the sample was filled into the mold. The upper thereof was covered with a polyester film applied with a releasing agent. This was taken out from the mold, and subjected to polymerization and foaming in a hot wind furnace of 155° C. temperature for 30 minutes, so as to yield a thermally conductive sheet-form molded foam (1), both surfaces of which were covered with the polyester film applied with the releasing agent. The polymerization conversion ratio of the monomer mixture (A2m) was calculated from the amount of the monomers remaining in the sheet. As a result, the ratio was 99.9%. About this thermally conductive sheet-form molded foam (1), each of the properties was evaluated. The results are shown in Table 2.

### Comparative Example 1

The same operations as in Example 1 were performed except that 200 parts of aluminum oxide (alumina) were used instead of 200 parts of aluminum hydroxide, so as to yield a thermally conductive sheet-form molded foam (2), both surfaces of which were covered with the polyester film applied with the releasing agent. About this thermally conductive sheet-form molded foam (2), each of the properties was evaluated. The results are shown in Table 2.

### Comparative Example 2

The same operations as in Example 1 were performed except that p,p′-oxybis (benzenesulfonylhydrazide) (OBSH) was not used, so as to yield a thermally conductive, non-foamed sheet-form molded body (3). About this thermally conductive sheet-form molded body (3), each of the properties was evaluated. The results are shown in

Table 2.

TABLE 2

| | Exam- | Comparative | Comparative |
|---|---|---|---|
| | ple 1 | Example 1 | Example 2 |
| Blended Materials [parts] | | | |
| Copolymer (A1) [parts] | 100 | 100 | 100 |
| 2-Ethylhexyl acrylate units [%] | 94 | 94 | 94 |
| Acrylic acid units [%] | 6 | 6 | 6 |
| Monomer mixture (A2m) [parts] | 44.5 | 44.5 | 44.5 |
| n-Butyl acrylate [%] | 50.6 | 50.6 | 50.6 |
| 2-Ethylhexyl acrylate [%] | 33.7 | 33.7 | 33.7 |
| Methacrylic acid [%] | 11.2 | 11.2 | 11.2 |
| PEGDMA [%] | 4.5 | 4.5 | 4.5 |
| Polymerization Initiator [parts] | | | |
| TMCH | 1.6 | 1.6 | 1.6 |
| The number of the parts | 3.6 | 3.6 | 3.6 |
| for 100 parts by weight | | | |
| of A2m [parts] | | | |
| Metal hydroxide (B) [parts] | | | |
| Alminum hydroxide [parts] | 200 | — | 200 |
| Alminum oxide [parts] | — | 200 | — |
| The number of the parts | 138 | 138 | 138 |
| for 100 parts by weight | | | |
| of the total of A1 | | | |
| and A2m [parts] | | | |
| Foaming Agent [parts] | | | |
| OBSH | 1.0 | 1.0 | — |
| The number of the parts | 0.69 | 0.69 | — |
| for 100 parts by weight | | | |
| of the total of A1 and | | | |
| A2m [parts] | | | |
| Foaming Multiplying Factor | 1.25 | 1.25 | 1.00 |
| [times] | | | |
| Sheet Properties | | | |
| Hardness (ASKER C) | 34 | 36 | 45 |
| Thermal conductivity [W/m · K] | 0.6 | 0.6 | 0.7 |
| Room-temperature adhesive | 2.3 | 2.1 | 2.5 |
| force [N/cm] | | | |
| High-temperature adhesive | 0.7 | 0.6 | 0.7 |
| force [N/cm] | | | |
| Shape-conformability [%] | 95 | 93 | 45 |
| Flame resistance (UL94) | V-2 | Spreading fire | V-2 |

From the results in Table 2, the following can be understood.

In Example 1, wherein a thermally conductive sheet-form molded foam was prepared by mixing the copolymer (A1), the monomermixture (A2m), the thermal polymerization initiator (E2), the thermally-decomposable foaming agent, and the metal hydroxide (B) to yield a mixture; polymerizing the monomers, foaming the obtained polymer and making the resultant into a sheet while heating, the resultant thermally conductive sheet-form molded foam was favorable in hardness and excellent in the adhesive forces, shape-conformability and flame resistance. On the other hand, in Comparative Example 1, wherein the composition of all monomers was the same as that of in Example 1 except aluminum oxide (alumina) instead of aluminum hydroxide, the flame resistance was deteriorated. In Comparative Example 2, wherein foaming was not performed, the shape-conformability was deteriorated.

The following will describe reference examples for helping the understanding of the invention.

### Reference Example 1, and Reference Comparative Example 1

The method for evaluating each of the properties of any acrylic (ormethacrylic) estercopolymer (A), thermally conductive pressure-sensitive adhesive composition, and thermally conductive sheet-form molded body is the same as described in the above-mentioned Examples. Evaluating methods adopted newly in Reference Example 1 and Reference Comparative Example 1 are as follows.

(9) Easy-peeling property

A 50 mm ×150 mm test piece was put between an aluminum plate and a glass plate each having the same size as that of the piece, and the piece was stuck thereto. The resultant was compressed with a 2-kg roller to bond and then allowed to stand still for one hour. This sample was set into a thermostat bath, whose temperature was set to 180° C., and was allowed to stand still for one hour. Immediately thereafter, a scraper 0.5 mm thick was inserted into the test piece stuck between the aluminum plate and the glass plate, and then forced thereinto in the longitudinal direction. At this time, the situation that the test piece was peeled was observed.

◯: The heat radiating sheet was easily pealed off from the aluminum plate and the glass plate. A very large force was not required for the peeling-off.

Δ: The heat radiating sheet was peeled off from the aluminum plate and the glass plate. However, a large force was necessary for the peeling-off.

x: The heat radiating plate was unable to be peeled off from the aluminum plate nor the glass plate.

(1) Flame resistance

A test was made in accordance with the UL standard UL94 “TESTS FOR FLAMMABILITY OF PLASTIC MATERIALS FOR PARTS IN DEVICES”, so as to evaluate flame resistance. A sheet-form sample was put into a cylinder. Flame was brought into contact with the sample for 10 seconds. Immediately after lingering flame burning stopped, second flame was again brought into contact with the same sample for 10 seconds. The sample was then evaluated about test items shown in Table 1. The test was made about five samples per the same test kinds. Based on the results, classification into burning classes shown in Table 1 was performed.

### Reference Example 1

Into a mortar for a pulverizer were put 100 parts of the same copolymer (A1) (1) as yielded in Example 1, 44.5 parts of the same monomer mixture (A2m) (1) as in Example 1, 1.6 parts of TMCH as a polymerization initiator, 3.0 parts of ethylene bisstearic amide as the compound (D), and 200 parts of aluminum hydroxide all together at once. The components were sufficiently mixed in a pulverizer at room temperature. At this time, the ratio by weight of aluminum hydroxide to 100 parts of the total of the copolymer (A1) (1) and the monomer mixture (A2m) (1) was 138 parts, and the ratio by weight of ethylene bisstearic amide thereto was 2.1 parts. Thereafter, the mixture was defoamed while stirring under reduced pressure, so as to yield a viscous liquid sample. A polyester film applied with a releasing agent was laid onto the bottom surface of a mold of 400 mm long, 400 mm wide and 2 mm deep, and then the sample was filled into the mold. The upper thereof was covered with a polyester film applied with a releasing agent. This was taken out from the mold, and subjected to press polymerization by use of an oil hydraulic press at 130° C. and a pressure of 0.5 MPa for 30 minutes, so as to yield a thermally conductive sheet-form molded body (4), both surfaces of which were covered with the polyester film applied with the releasing agent. The polymerization conversion ratio of the monomer mixture (A2m) was calculated from the amount of the monomers remaining in the sheet. As a result, the ratio was 99.9%. About this thermally conductive sheet-form molded body (4), each of the properties was evaluated. The results are shown in Table 3.

### Reference Comparative Example 1

The same operations as in Reference Example 1 were performed except that ethylene bisstearic amide was not used, so as to yield a thermally conductive sheet-form molded body (5), both surfaces of which were covered with the polyester film applied with the releasing agent. About this thermally conductive sheet-form molded body (5), each of the properties was evaluated. The results are shown in Table 3.

Table 3

TABLE 3

| | | Reference |
|---|---|---|
| | Reference | Comparative |
| | Example 1 | Example 1 |
| Blended Materials [parts] | | |
| Copolymer (A1) [parts] | 100 | 100 |
| 2-Ethylhexyl acrylate units [%] | 94 | 94 |
| Acrylic acid units [%] | 6 | 6 |
| Monomer mixture (A2m) [parts] | 44.5 | 44.5 |
| n-Butyl acrylate [%] | 50.6 | 50.6 |
| 2-Ethylhexyl acrylate [%] | 33.7 | 33.7 |
| Methacrylic acid [%] | 11.2 | 11.2 |
| PEGDMA [%] | 4.5 | 4.5 |
| Polymerization Initiator [parts] | | |
| TMCH (*6) [parts] | 1.6 | 1.6 |
| The number of the parts for 100 parts by | 3.6 | 3.6 |
| weight of A2m [parts] | | |
| Metal hydroxide (B) [parts] | | |
| Alminum hydroxide [parts] | 200 | 200 |
| The number of the parts for 100 parts by | 138 | 138 |
| weight of the total of A1 and A2m [parts] | | |
| Compound (D) [parts] | | |
| Ethylene bisstearic amide [parts] | 3.0 | — |
| The number of the parts for 100 parts by | 2.1 | — |
| weight of the total of A1 and A2m [parts] | | |
| Sheet Properties | | |
| Hardness (ASKER C) | 45 | 45 |
| Thermal conductivity [W/m · K] | 0.7 | 0.7 |
| Room-temperature adhesive force [N/cm] | 2.4 | 2.5 |
| High-temperature adhesive force [N/cm] | 0.7 | 0.7 |
| Easy-peeling Property at 150° C. | ◯ | Δ |
| Flame resistance (UL94) | V-2 | V-2 |

From the results in Table 3, the following can be understood.

In Reference Example 1, wherein a thermally conductive sheet-form molded body was prepared by mixing the copolymer (A1), the monomer mixture (A2m), the thermal polymerization imitator (E2), the metal hydroxide (B), and the compound (D) to yield a mixture, and preparing a thermally conductive pressure-sensitive adhesive composition while heating the mixture at the same time when making the composition into a sheet, the resultant thermally conductive sheet-form molded body was excellent in thermal conductivity and adhesive property in the range of ordinary use temperatures, and had an easy-peeling property at 180° C. On the other hand, in Reference Comparative Example 1, wherein no compound (D) was used, the molded body was deteriorated in easy-peeling property.

### Reference Examples 2 to 5, and Reference Comparative Examples 2 to 6

Evaluating methods adopted in Reference Examples 2 to 5, and Reference Comparative Examples 2 to 6 are as follows.

(1) Sheet Smoothness (μm)

A dial gauge was used to measure the thickness of a sheet in a thermally conductive sheet-form molded body used in each of the reference examples and the reference comparative examples. The thickness was measured at 10 spots per sheet. The difference between the maximum value and the minimum value of the measured results was calculated, thereby specifying the value of the sheet smoothness. As the value of the sheet smoothness in Table 6 is smaller, the sheet smoothness is higher.

(2) Product Width (mm)

A steel measure was used to measure the width of the thermally conductive sheet-form molded body used in each of the reference examples and the reference comparative examples. The width was measured at 2 spots per sheet. The average of the measured results were defined as the width of each of the sheets. The regular value of the width of the thermally conductive sheet-form molded body used in each of the reference examples and the reference comparative examples was set to 250 mm, and the difference between each width and this regular value is described in Table 6. Accordingly, as the value of the product width in Table 6 is smaller, the moldability (formability) of the sheet is higher.

(General Production Process)

Thermally conductive sheet-form molded bodies produced in Reference Examples 2 to 5, and Reference Comparative Examples 2 to 6, which will be described below, were produced by the following method.

A copolymer (A1), a monomer mixture (A2m), aluminum hydroxide, silica (C), a polymerization initiator, and an external crosslinking agent were sequentially added into a biaxial extruder whose internal temperature was controlled at 50° C., wherein L/D=48 (the same direction), and then a condition that the rotation number of its screw was 200 rotations/minute was set and the biaxial extruder was driven. At the time of driving the biaxial extruder, the inside of the biaxial extruder was turned to be in a vacuum state, so as to set the pressure in a vent in the extruder to 1013 hPa. The starting materials were then dispersed and mixed, thereby yielding each thermally conductive pressure-sensitive adhesive composition. Next, the resultant thermally conductive pressure-sensitive adhesive composition was cast onto a stretched polyester film, a single surface of which was subjected to releasing treatment with a silicone, and then the composition was covered with a stretched polyester film, a single surface of which was subjected to releasing treatment with a silicone. Thereafter, the thickness and the width of the thermally conductive pressure-sensitive adhesive composition were adjusted to 1.0 mm and 250 mm, respectively. Thereafter, the composition, the thickness and the width of which were adjusted, was held in a Mathis oven (Mathis LABCOATER Type Let-S, manufactured by Werner Mathis AG), the internal temperature of which was controlled to 150° C., for 30 minutes, thereby yielding a thermally conductive sheet-form molded body used in each of the reference examples and reference comparative examples of the invention.

### Reference Example 2

A thermally conductive sheet-form molded body used in the present reference example was produced, using 42.5 parts by weight of a monomer mixture (A2m) (2), 0.5 parts by weight of a thermal polymerization initiator (E2), .1.0 part by weight of silica 1 (C) (1), 200 parts by weight of aluminum hydroxide (B) (1) and 1.0 part by weight of an external crosslinking agent for 100 parts by weight of the same copolymer (A1) (1) as obtained in Example 1.

The monomer mixture (A2m) (2) was composed of 22.5 parts by weight of a n-butyl acrylate monomer, 15.0 parts by weight of a 2-ethylhexyl acrylate monomer, and 5.0 parts by weight of methacrylic acid. The thermal polymerization initiator (E2) was 1,1-bis(t-butylperoxy)-3,3,5-trimethylcyclohexane, and the silica 1 (C) (1) was AEROSIL200 (AEROSIL is a registered trademark of Degussa Co., this matter being the same in the following description) shown in Table 3. The external crosslinking agent was pentaerythritol triacrylate.

About the sheet properties of the thermally conductive sheet-form molded body in the present reference example, produced by use of the above-mentioned raw materials, the value of the sheet smoothness was 13 μm and the value of the product width was+4 mm, as shown in Table 6. Accordingly, the thermally conductive sheet-form molded body used in the present reference example had a high sheet smoothness and a high moldability since the molded body had a sheet smoothness value of less than 20 μm and a product width value of less than+10 mm.

As shown in Table 5, about the silica 1 (C) (1) used in the present reference example, the hydrophobicity ratio based on the transmissivity method was 8% and the primary average particle diameter was 12 nm. Thus, the molded body had the highest sheet smoothness among reference examples. It was therefore understood that it is effective to use silica (C) wherein the hydrophobicity ratio based on the transmissivity method is 10% or less in order to obtain a high sheet smoothness.

### Reference Comparative Example 2

A thermally conductive sheet-form molded body used in the present reference comparative example was produced by use of the same raw materials in the same amounts as in Reference Example 2 except that the silica 1 (C) (1) was not used. Since neither the silica 1 (C) (1) nor any silica itself was used in the present reference comparative example, the sheet properties of the thermally conductive sheet-form molded body were as follows: the sheet smoothness value was 95 μm and the product width value was +20 mm as shown in Table 6. In other words, both of the sheet smoothness value and the product width value were larger than those in Reference Example 2, and the sheet smoothness value and the product width value were more than 20 μm and more than+10 mm, respectively, so that the sheet smoothness and the moldability became low. It is therefore effective to use silica (C) in order to yield a high sheet smoothness and a high moldability.

### Reference Example 3

A thermally conductive sheet-form molded body used in the present reference example was produced by use of the same raw materials in the same amounts as in Reference Example 2 except the used amount of the silica 1 (C) (1). The used amount of the silica 1 (C) (1) was set to 0.5 parts by weight. Since 0.5 parts by weight of the silica 1 (C) (1) was used and the amount was a half of the used amount of the silica 1 (C) (1) in Reference Example 2 in the present reference example, the sheet smoothness value and the product width value were 15 μm and +6 mm, respectively, which were larger than those in Reference Example 2. However, in the present reference example, the sheet smoothness value and the product width value were less than 20 μm and less than+10 mm, respectively; therefore, the molded body was permitted to have appropriate quality in both of sheet smoothness and moldability even if the used amount of the silica 1 (C) (1) was 0.5 parts by weight.

### Reference Comparative Example 3

A thermally conductive sheet-form molded body used in the present reference comparative example was produced by use of the same raw materials in the same amounts as in Reference Example 2 except that 1.0 part by weight of silica 3 (C) (3) was used instead of 1.0 part by weight of the silica 1 (C) (1) used in Reference Example 2. As shown inTable5, the silica 3 (C) (3) usedinthepresent reference comparative example was AEROSIL R972, and the hydrophobicity ratio of the silica 3 (C) (3) based on the transmissivity method was 55%, which was more than 50%. Since the silica 3 (C) (3), wherein the hydrophobicity ratio based on the transmissivity method was more than 50%, was used in the thermally conductive sheet-form molded body used in the present reference comparative example, the sheet properties thereof were as follows: the sheet smoothness value and the product width value were 98 μm and +20 mm, respectively. In other words, both of the sheet smoothness value and the product width value were larger than the values in Reference Example 2, and the sheet smoothness value and the product width value were more than 20 μm and more than+10 mm, respectively. Thus, both of the sheet smoothness and the moldability lowered. It is therefore effective to use silica (C) wherein the hydrophobicity ratio based on the transmissivity method is 50% or less in order to obtain a high sheet smoothness and a high moldability.

### Reference Example 4

A thermally conductive sheet-form molded body used in the present reference example was produced by use of the same raw materials in the same amounts as in Reference Example 2 except that 1.0 part by weight of silica 2 (C) (2) was used instead of 1.0 part by weight of the silica 1(C) (1) used in Reference Example 2. As shown in Table 5, the silica 2 (C) (2) used in the present reference example was AEROSIL 200V, and the hydrophobicity ratio of the silica 2(C) (2) based on the transmissivity method was 8%, which was not more than 10%. Since the silica 2 (C) (2), wherein the hydrophobicity ratio based on the transmissivity method was not more than 50%, was used in the thermally conductive sheet-form molded body used in the present reference example, the sheet properties thereof were as follows: the sheet smoothness and the product width were 13 μm and +3 mm, respectively, as shown in Table 6. In other words, the sheet smoothness value was less than 20 μm and the product width value was less than +10 mm; thus, the thermally conductive sheet-form molded body used in the present reference example had a high sheet smoothness and a high moldability.

### Reference Comparative Example 4

A thermally conductive sheet-form molded body used in the present reference comparative example was produced by use of the same raw materials in the same amounts as in Reference Example 2 except that 1.0 part by weight of silica 4 (C) (4) was used instead of 1.0 part by weight of the silica 1 (C) (1) used in Reference Example 2. As shown in Table 5, the silica 4 (C) (4) used in the present reference comparative example was AEROSIL R805, and the hydrophobicity ratio of the silica 4 (C) (4) based on the transmissivity method was 60%, which was more than 50%. Since the silica 4 (C) (4), wherein the hydrophobicity ratio based on the transmissivity method was more than 50%, was used in the thermally conductive sheet-form molded body used in the present reference comparative example, the sheet properties thereof were as follows: the sheet smoothness and the product width were 100 μm and +20 mm, respectively. In the same manner as in the case of Reference Comparative Example 3 using the silica 3 (C) (3) wherein the hydrophobicity ratio based on the transmissivity method was more than 50%, the sheet smoothness value and the product width value were more than 20 μm and more than +10 mm, respectively. Thus, both of the sheet smoothness and the moldability lowered. It is therefore effective to use silica (C) wherein the hydrophobicity ratio based on the transmissivity method is 50% or less in order to obtain a high sheet smoothness and a high moldability.

### Reference Example 5

A thermally conductive sheet-form molded body used in the present reference example was produced by use of the same raw materials in the same amounts as in Reference Example 2 except that 0.5 parts by weight of silica 2 (C) (2) was used instead of 1.0 part by weight of the silica 1 (C) (1) used in Reference Example 2. As shown in Table 5, in the present reference example, the silica 2 (C) 2 was used in the same way as in Reference Example 4; accordingly, the sheet properties thereof were as follows: the sheet smoothness and the product width were 19 μm and +3 mm, respectively, as shown in Table 6. Thus, the product width value was similar to that in Reference Example 4, but the sheet smoothness value was larger than the value in Reference Example 4. However, the sheet smoothness value and the product width value in the reference example were less than 20 μm and less than +10 mm, respectively; therefore, the molded body was permitted to have appropriate quality in both of sheet smoothness and moldability even if the used amount of the silica 2 (C) (2) was 0.5 parts by weight.

### Reference Comparative Example 5

A thermally conductive sheet-form molded body used in the present reference comparative example was produced by use of the same raw materials in the same amounts as in Reference Example 2 except that 0.5 parts by weight of silica 3 (C) (3) and 0.5 parts by weight of silica 4 (C) (4) were used instead of 1.0 part by weight of the silica 1 (C) (1) used in Reference Example 2. As shown in Table 5, the hydrophobicity ratios, based on the transmissivity method, of the silica 3 (C) (3) and the silica 4 (C) (4) used in the present reference comparative examples were 55% and 60%, respectively, which were more than 50%. As shown in Table 6, therefore, the sheet properties of the thermally conductive sheet-form molded body used in the present reference comparative example were as follows: the sheet smoothness and the product width were 102 μm and +21 mm, respectively, and were more than 20 μm and more than +10 mm, respectively. Thus, both of the sheet smoothness and the moldability lowered. It was therefore understood that silica wherein the hydrophobicity ratios based on the transmissivity method is more than 50% gives neither a high smoothness nor a high moldability even if a half of the used amount in Reference Comparative Example 3 and a half of the used amount in Reference Comparative Example 4 are mixed with each other and are used.

### Reference Comparative Example 6

A thermally conductive sheet-form molded body used in the present reference comparative example was produced by use of the same raw materials in the same amounts as in Reference Example 2 except that 1.0 part by weight of silica 5 (C) (5) was used instead of 1.0 part by weight of the silica 1 (C) (1) used in Reference Example 2. As shown inTable 5, the silica 5 (C) (5) used in the present reference comparative example was AEROSIL 50, and the average particle diameter of primary particles in the silica 5 (C) (5) was approximately 30 nm. In the thermally conductive sheet-form molded body used in the present reference comparative example, the silica 5 (C) (5) having this average particle diameter was used; as shown in 6, therefore, the sheet properties thereof were as follows: the sheet smoothness value was 19 μm, which was less than 20 μm, and the product width value was +19 mm, which was more than +10 mm. In other words, the thermally conductive sheet-formmolded body in the present reference comparative example using the silica 5 (C) (5), wherein the average particle diameter of primary particles was approximately 30 nm, which was more than 20 nm, had a high sheet smoothness but the fluidity-suppressing function in the sheet-form molded body lowered so that the moldability thereof was deteriorated. In order to obtain both of a high sheet smoothness and a high moldability simultaneously, it is necessary that the average particle diameter of the primary particles is 20 nm or less. Therefore, in order to satisfy this condition, it is essential that the average particle diameter of the primary particles in the silica (C) used in the invention is 20 nm or less.

About the blended materials in the above-mentioned Reference Examples 2 to 5 and Reference Comparative Examples 2 to 6, the respective weights of the blended materials are collectively shown in Table 4, the weights being those when the blended amount of the blended material Al is regarded as 100 parts by weight.

Table 4

TABLE 4

| | | | Reference | | Reference | | Reference | | Reference | Reference |
|---|---|---|---|---|---|---|---|---|---|---|
| | | Reference | Comparative | Reference | Comparative | Reference | Comparative | Reference | Comparative | Comparative |
| Blended Materials | | Example 2 | Example 2 | Example 3 | Example 3 | Example 4 | Example 4 | Example 5 | Example 5 | Example 6 |
| A1 | Copolymer | 100 | 100 | 100 | 100 | 100 | 100 | 100 | 100 | 100 |
| Am2 | n-Butyl acrylate | 22.5 | 22.5 | 22.5 | 22.5 | 22.5 | 22.5 | 22.5 | 22.5 | 22.5 |
| | 2-Ethylhexyl acrylate | 15.0 | 15.0 | 15.0 | 15.0 | 15.0 | 15.0 | 15.0 | 15.0 | 15.0 |
| | Methacrylic acid | 5.0 | 5.0 | 5.0 | 5.0 | 5.0 | 5.0 | 5.0 | 5.0 | 5.0 |
| E2 | Thermal | 0.5 | 0.5 | 0.5 | 0.5 | 0.5 | 0.5 | 0.5 | 0.5 | 0.5 |
| | Polymerization | | | | | | | | | |
| | Initiator | | | | | | | | | |
| | External Crosslinking | 1.0 | 1.0 | 1.0 | 1.0 | 1.0 | 1.0 | 1.0 | 1.0 | 1.0 |
| | Agent | | | | | | | | | |
| B | Alminum hydroxide | 200 | 200 | 200 | 200 | 200 | 200 | 200 | 200 | 200 |
| C | Silica 1 | 1.0 | — | 0.5 | — | — | — | — | — | — |
| | Silica 2 | — | — | — | — | 1.0 | — | 0.5 | — | — |
| | Silica 3 | — | — | — | 1.0 | — | — | — | 0.5 | — |
| | Silica 4 | — | — | — | — | — | 1.0 | — | 0.5 | — |
| | Silica 5 | — | — | — | — | — | — | — | — | 1.0 |

Table 5 shows properties of the silicas each used as one out of the raw materials in the above-mentioned Reference Examples 2 to 5 and Reference Comparative Examples 2 to 6.

Table 5

TABLE 5

| | AEROSIL 200 | AEROSIL 200V | AEROSIL R972 | AEROSIL R805 | AEROSIL 50 |
|---|---|---|---|---|---|
| Surface area based on the BET | 200 ± 25 | 200 ± 25 | 110 ± 20 | 150 ± 25 | 50 ± 15 |
| method (m²/g) | | | | | |
| Average particle diameter of | approx. 12 | approx. 12 | approx. 16 | approx. 12 | approx. 30 |
| Primary particles (nm) | | | | | |
| True specific gravity | 2.2 | 2.2 | 2.2 | 2.2 | 2.2 |
| Apparent density (g/l) | 50 | 100 | 50 | 50 | 50 |
| Hydrophobicity ratio based on | 8 | 8 | 55 | 60 | 10 |
| the transmissivity method (%) | | | | | |

Table 6 shows the sheet properties evaluated about the thermally conductive sheet-form molded bodies produced in the above-mentioned Reference Examples 2 to 5 and Reference Comparative Examples 2 to 6.

Table 6

TABLE 6

| | | Reference | | Reference | | Reference | | Reference | Reference |
|---|---|---|---|---|---|---|---|---|---|
| Sheet | Reference | Comparative | Reference | Comparative | Reference | Comparative | Reference | Comparative | Comparative |
| Properties | Example 2 | Example 2 | Example 3 | Example 3 | Example 4 | Example 4 | Example 5 | Example 5 | Example 6 |
| Sheet | 13 | 95 | 15 | 98 | 13 | 100 | 19 | 102 | 19 |
| smoothness (μm) | | | | | | | | | |
| Product | +4 | +20 | +6 | +20 | +3 | +20 | +3 | +21 | +19 |
| width (mm) | | | | | | | | | |

1. A thermally conductive pressure-sensitive adhesive composition, comprising 100 parts by weight of an acrylic (or methacrylic) ester copolymer (A) obtained by polymerizing 5 to 70 parts by weight of a monomer mixture (A2m) comprising 40 to 100% by weight of an acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight,
in the presence of 100 parts by weight of a copolymer (A1) comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) having a functional group other than any organic acid group, and 0 to 10% by weight of monomer units (a4) copolymerizable with these monomer units, when the total monomer mixture (A1) is regarded as 100% by weight, and
70 to 170 parts by weight of a metal hydroxide (B),
wherein the acrylic (or methacrylic) ester copolymer (A) is foamed.

2. The thermally conductive pressure-sensitive adhesive composition according to claim 1, wherein the multiplying factor of the foaming is from1.05 to1.4 times.

3. The thermally conductive pressure-sensitive adhesive composition according to claim 1, further comprising0.1 to5parts by weight of silica (C) comprising primary particles having an average particle diameter of 5 to 20 nm and having a hydrophobicity ratio of 50% or less when it is based on a transmissivity method.

4. The thermally conductive pressure-sensitive adhesive composition according to claim 1, which further comprises 0.05to 10 parts by weight of a compound (D) having a melting point of 120 to 200° C. and a molecular weight of less than 1000.

5. The thermally conductive pressure-sensitive adhesive composition according to claim 4, wherein the compound (D) is an aliphatic amide compound.

6. The thermally conductive pressure-sensitive adhesive composition according to claim 1, wherein the metal hydroxide (B) is aluminum hydroxide.

7. A thermally conductive sheet-form molded foam comprising the thermally conductive pressure-sensitive adhesive composition as described in claim 1.

8. A thermally conductive sheet-form molded foam, which comprises: a substrate; and one or more layers made of the thermally conductive pressure-sensitive adhesive composition as described in claim 1 and formed on a single surface or both surfaces of this substrate.

9. A process for producing a thermally conductive sheet-form molded foam, which comprises:
the step of mixing 100 parts by weight of a copolymer (A1) comprising 80 to 99.9% by weight of acrylic (or methacrylic) ester monomer units (a1) capable of forming a homopolymer having a glass transition temperature of −20° C. or lower, 0.1 to 20% by weight of monomer units (a2) having an organic acid group, 0 to 10% by weight of monomer units (a3) comprising a functional group other than any organic acid group, and 0 to 10% by weight of monomer units (a4) copolymerizable with these monomer units, when the total copolymer (A1) is regarded as 100% by weight, 5 to 70 parts by weight of a monomer mixture (A2m) comprising 40 to 100% by weight of a acrylic (or methacrylic) ester monomer (a5m) capable of forming a homopolymer having a glass transition temperature of −20° C. or lower, 0 to 60% by weight of a monomer (a6m) having an organic acid group, and 0 to 20% by weight of a monomer (a7m) copolymerizable with these monomers, when the total monomer mixture (A2m) is regarded as 100% by weight,
a thermal polymerization initiator (E2) in an amount of 0.1 to 50 parts by weight for 100 parts by weight of the monomer mixture (A2m),
a metal hydroxide (B) in an amount of 70 to 170 parts by weight for 100 parts by weight of the total of the copolymer (A1) and the monomer mixture (A2m), thereby forming a mixture (F);
the step of foaming the mixture (F); the step of heating the mixture (F); and the step of making the mixture (F) into a sheet.

10. The process for producing a thermally conductive sheet-form molded foam according to claim 9, wherein the step of the foaming the mixture (F) is a step of foaming the mixture (F) to set the foaming multiplying factor thereof into the range of 1.05 to 1.4 times.

11. The process for producing a thermally conductive sheet-form molded foam according to claim 10, wherein the mixture (F) is a mixture wherein 0.1 to 5 parts by weight of silica (C) comprising primary particles having an average particle diameter of 5 to 20 nm and having a hydrophobicity ratio of 50% or less when it is based on a transmissivity method, are further mixed with 100 parts by weight of the total of the copolymer (A1) and the monomer mixture (A2m).

12. The process for producing a thermally conductive sheet-form molded foam according to claim 10, wherein the mixture (F) is a mixture (G) wherein 0.05 to 10 parts by weight of a compound (D) having a melting point of 120 to 200° C. and a molecular weight of less than 1000 are further mixed with 100 parts by weight of the total of the copolymer (A1) and the monomer mixture (A2m).

13. The process for producing a thermally conductive sheet-form molded foam according to claim 12, wherein the mixture (G) is a mixture wherein 0.1 to 5 parts by weight of silica (C) comprising primary particles having an average particle diameter of 5 to 20 nm and having a hydrophobicity ratio of 50% or less when it is based on a transmissivity method, are further mixed with 100 parts by weight of the total of the copolymer (A1) and the monomer mixture (A2m).

14. The process for producing a thermally conductive sheet-form molded foam according to claim 10, wherein the mixture (F) is a mixture (G′) wherein 0.05 to 10 parts by weight of an aliphatic amide compound having a melting point of 120 to 200° C. and a molecular weight of less than 1000 are further mixed with 100 parts by weight of the total of the copolymer (A1) and the monomer mixture (A2m).

15. The process for producing a thermally conductive sheet-form molded foam according to claim 14, wherein the mixture (G′) is a mixture wherein 0.1 to 5 parts by weight of silica (C) comprising primary particles having an average particle diameter of 5 to 20 nm and having a hydrophobicity ratio of 50% or less when it is based on a transmissivity method, are further mixed with 100 parts by weight of the total of the copolymer (A1) and the monomer mixture (A2m).

16. The process for producing a thermally conductive sheet-form molded foam according to claim 9, wherein the metal hydroxide (B) is aluminum hydroxide.
